(19) United States
(12) Patent Application Publication
(10) Pub. No.: US 2026/0193904 A1
(43) Pub. Date: Jul. 9, 2026

(54) Clutch Structure for Combination Lock

(71) Applicant: Wenzhou Haodi Hardware Decoration Co., Ltd, Zhejiang (CN)

(72) Inventor: Min YAN, Zhejiang (CN)

(73) Assignee: Wenzhou Haodi Hardware Decoration Co., Ltd, Zhejiang (CN)

(21) Appl. No.: 19/082,477

(22) Filed: Mar. 18, 2025

(30) Foreign Application Priority Data
Jan. 6, 2025 (CN) 202520015873.3

(51) Int. Cl. E05B 53/00; E05B 37/02; F16D 11/16

(52) U.S. Cl. CPC E05B 53/00; E05B 37/02; F16D 11/16

(57) ABSTRACT

The present disclosure discloses a clutch structure for a combination lock, comprising a combination lock module, which comprises a fixed ring and a lock cylinder connected to the fixed ring. One end of the lock cylinder is provided with ratchet teeth, and the side of the lock cylinder is provided with a Rotational detent step. One end of the lock cylinder is provided with a lock bar fixing block located within the Rotational detent step, and the lock bar fixing block is connected via a first pin to a lock bar body that meshes with the ratchet teeth.

### CROSS-REFERENCE TO RELATED APPLICATIONS

This application claims priority to Chinese Patent Application No. 202520015873.3, filed on Jan. 6, 2025, titled “Clutch Structure for Combination Lock,” the entire contents of which, including any amendments, are incorporated herein by reference.

### TECHNICAL FIELD

The present disclosure relates to the field of mechanical combination lock technology, particularly to a clutch structure for a combination lock.

### BACKGROUND

Mechanical combination locks typically use mechanical components such as gears, levers, and cams to achieve password input and lock opening. Taking the dial-type mechanical combination lock as an example, when the dial is rotated, the internal cam mechanism is driven through gear transmission. Only when the position of the cam completely matches the preset password position can the bolt be pushed to open the lock.

There exists, for example, U.S. Pat. No. 6,904,776, which discloses a combination lock that can be opened with a key. In addition to the typical opening method by arranging the dial to the user's desired numerical sequence, the combination lock can also be opened by authorized personnel using a key. Although this patent may be suitable for its specific intended purpose, it still has certain drawbacks, such as weak components, the possibility of the sealing cover becoming loose, and difficulty in manufacturing due to excessive internal components. Furthermore, in most mechanical combination locks, the lock cylinder and the lock bar are fixedly connected and are driven simultaneously. When the lock cylinder is accidentally touched, it causes the lock bar to rotate simultaneously, which needs to be improved.

### SUMMARY

The present disclosure provides a clutch structure for a combination lock to solve the problems raised in the background technology.

To achieve the above-mentioned object of the present disclosure, the present disclosure adopts the following technical solution:
A clutch structure for a combination lock includes a combination lock module comprising a fixed ring and a lock cylinder connected to the fixed ring, wherein one end of the lock cylinder is provided with ratchet teeth, a side of the lock cylinder is provided with a rotational detent step, and one end of the lock cylinder is provided with a lock bar fixing block located within the rotational detent step, wherein the lock bar fixing block is connected to a lock bar body via a first pin, the rotational detent step is connected to the lock bar fixing block via a second pin, and a spring is arranged between the fixed ring and the lock bar fixing block.

### BRIEF DESCRIPTION OF DRAWINGS

The drawings, which constitute a part of this application, are provided to further explain the present disclosure. The illustrative embodiments and the descriptions thereof are used to explain the present disclosure and do not constitute an improper limitation of the present disclosure. In the drawings:

FIG. 1 is a schematic diagram of the clutch structure of the combination lock in this application;

FIG. 2 is a schematic diagram of the combination lock assembly with the rotational detent step removed in this application;

FIG. 3 is a schematic diagram of the structure of FIG. 2 from another perspective;

FIG. 4 is an exploded schematic diagram of the clutch structure of the combination lock in this application;

FIG. 5 is another exploded schematic diagram of the clutch structure for a combination lock in this application.

### REFERENCE SIGNS

Fixed ring (1); Lock cylinder (2); Ratchet tooth (3); Rotational detent step (4); Lock bar fixing block (5); Lock bar body (6); Spring (7); Snap ring groove (8); Snap ring body (9); Round gasket (10); Annular groove (11); First pin (12); Combination disc (13); Combination tumbler wheel (14); Second through hole (16); Protrusion (17); Sliding groove (18); Second pin (19); Third pin (20).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

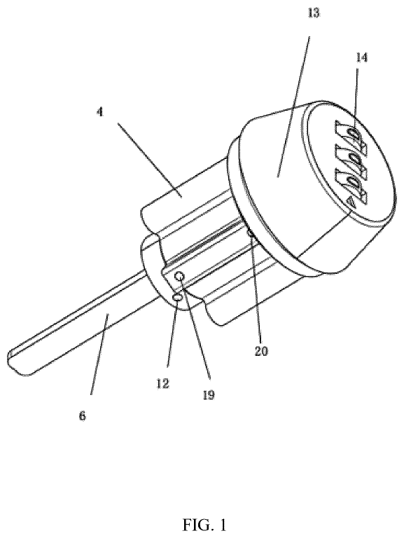

As shown in FIGS. 1 to 5, a clutch structure for a combination lock includes a combination lock module. The combination lock module includes a fixed ring 1 and a lock cylinder 2 connected to the fixed ring 1. One end of the lock cylinder 2 is provided with ratchet teeth 3. A side of the lock cylinder 2 is provided with a rotational detent step 4. One end of the lock cylinder 2 is provided with a lock bar fixing block 5 located inside the rotational detent step 4. The inside of the Rotational detent step 4 is provided with a cavity for the movement of the fixed ring 1. The rotational detent step 4 and the lock bar fixing block 5 are respectively located at the two axial ends of the cavity. A side of the fixed ring 1 is provided with a protrusion 17. The inner side of the rotational detent step 4 is axially provided with a sliding groove 18 for the protrusion 17 to slide. The sliding groove 18 is used to guide the fixed ring 1 to move axially and at the same time restricts the rotation of the fixed ring 1 relative to the rotational detent step 4.

The lock cylinder 2 has an end that passes through the fixed ring 1 and extends towards the lock bar fixing block 5. This end is equipped with ratchet teeth 3, and the lock bar fixing block 5 is provided with tooth slots that match the ratchet teeth 3. The lock cylinder 2 can move axially to selectively engage the ratchet teeth 3 with the lock bar fixing block 5. Only when engaged, the rotation of the lock cylinder 2 drives the lock bar body 6 to rotate synchronously. Furthermore, the lock cylinder 2 can move axially relative to the lock bar fixing block 5 and has a first working position and a second working position. When the lock cylinder 2 is in the first working position, the ratchet teeth 3 engage with the lock bar fixing block 5 to achieve synchronous rotation; when in the second working position, the ratchet teeth 3 disengage from the lock bar fixing block 5.

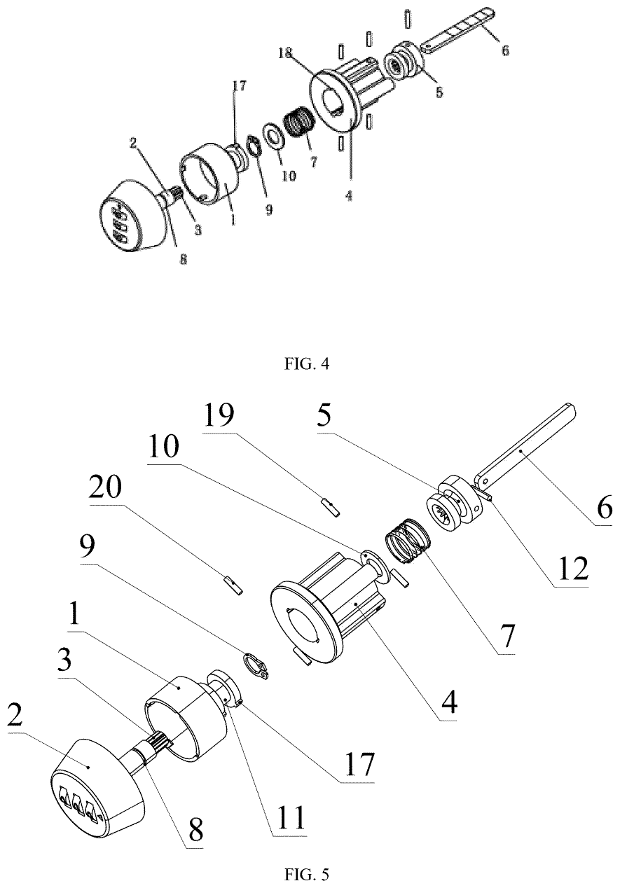

As shown in FIGS. 4-5, the guiding mechanism composed of the protrusion 17 and the sliding groove 18 (such as the guiding groove and the guiding pin) ensures the stability and linearity of the lock cylinder 2 during axial movement, preventing deviation or jamming.

The ratchet teeth 3 include but are not limited to flat key joint structures such as single key, cross key, spline key, and other tooth profile structures suitable for meshing transmission (such as involute teeth, helical teeth, circular arc teeth, etc.) to meet the transmission needs of different application scenarios. The ratchet teeth 3 and the tooth slots are designed as multi-stage meshing structures to increase the stability and load-bearing capacity of the transmission.

As shown in FIGS. 3 to 5, the lock bar fixing block 5 is fixedly connected to the lock bar body 6 through the first pin 12. This fixed connection allows the lock bar fixing block 5 and the lock bar body 6 to rotate synchronously. The lock bar fixing block 5 is coaxially arranged with the rotational detent step 4 and is capable of rotating relative to the rotational detent step 4.

The periphery of the lock bar fixing block 5 is provided with a circumferential groove, and the circumferential groove has corresponding shaft shoulders at both axial ends. The rotational detent step 4 is provided with second pins 19 that extend into the shaft shoulders at both ends of the circumferential groove. When the second pins 19 abut against the shaft shoulders, they prevent the axial movement of the lock bar fixing block 5, thereby restricting the lock bar fixing block 5 from axially disengaging from the rotational detent step 4. This design ensures that the lock bar fixing block 5 can be effectively limited in axial movement while allowing it to rotate relatively within the range of the circumferential groove, thus achieving the stability and reliability of the clutch function. In this embodiment, two second pins 19 are symmetrically arranged on both sides of the circumferential groove to provide dual limit protection, preventing the fixed ring 1 from disengaging under extreme conditions.

The middle part of the fixed ring 1 is provided with an inwardly recessed annular groove 11. The annular groove 11 has corresponding axial shoulders at both ends along the axial direction. The third pins 20, which are inserted through the rotational detent step 4, are located within the axial shoulders at both ends of the annular groove 11. When the third pins 20 abut against the shoulders, they prevent the fixed ring 1 from moving axially, thereby preventing the fixed ring 1 from axially disengaging from the rotational detent step 4. The shoulders at both ends of the annular groove 11 maintain a certain distance to avoid affecting the reciprocating movement stroke of the fixed ring 1 and the lock cylinder 2. This design effectively limits the axial movement range of the fixed ring 1 through the cooperation of the third pins 20 and the annular groove 11, while allowing the fixed ring 1 to make necessary axial adjustments within the range of the annular groove 11, thereby ensuring the stability and reliability of the clutch structure. In this embodiment, two third pins 20 are symmetrically arranged on both sides of the annular groove 11 to provide dual limit protection, preventing the fixed ring 1 from disengaging under extreme conditions. The limit device (i.e., the third pin 20) is set on the movement path of the lock cylinder 2 to restrict the maximum movement range of the lock cylinder 2, preventing structural damage caused by excessive pressing or pulling.

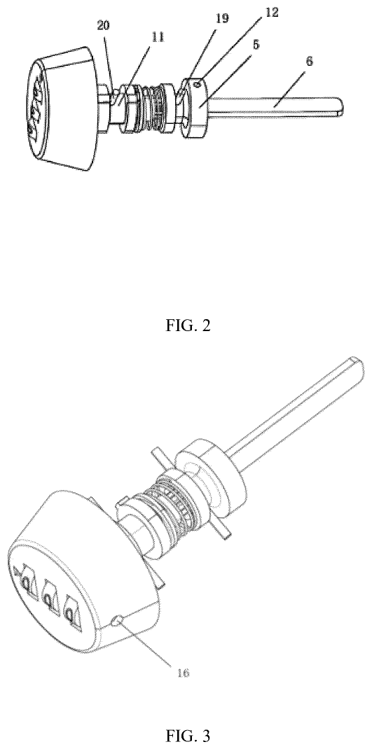

As shown in FIG. 2, an elastic reset mechanism (such as a spring 7) is added between the lock cylinder 2 and the fixed ring 1 to ensure that the lock cylinder 2 can automatically reset to the first working position when no external force is applied, thereby enhancing the stability and reliability of the clutch structure. In this embodiment, the specific implementation method is as follows: a spring 7 is installed between the fixed ring 1 and the lock bar fixing block 5. This spring 7 is used to provide elastic force to force the lock cylinder 2 to move from the second working position to the first working position, thus realizing the automatic reset function of the lock cylinder 2.

The middle part of the lock cylinder 2 is provided with a snap ring groove 8, and a snap ring is installed in the snap ring groove 8. The snap ring abuts against the fixed ring 1 to limit the axial displacement of the lock cylinder 2. At the same time, in the embodiment of this application, an elastic element or damping device can also be added inside the lock cylinder 2, so that when the user presses or pulls the lock cylinder 2 to achieve clutch engagement, they can feel a noticeable tactile feedback. For example, when pressing to achieve engagement, there is a slight “click” sound and a change in resistance, allowing the user to clearly know the operational status and enhancing the user experience.

A round gasket is placed between the snap ring and spring 7 to reduce the frictional effects generated during the rotation and axial movement of the lock cylinder 2. As a buffer and isolation component, the round gasket can effectively reduce direct contact friction between the snap ring and spring 7, thereby enhancing the smooth operation and service life of the clutch structure. In some embodiments (not shown), the contact surface of the round gasket is designed with a wave or serrated structure to increase the storage space for lubricant, reduce friction, and improve lubrication effectiveness.

As shown in FIGS. 1-3, the combination lock module further includes a combination disc 13. The combination disc 13 is provided with a plurality of independently rotatable combination tumbler wheels 14. Each combination tumbler wheel 14 is provided with a first through hole, and a side of the combination disc 13 is provided with a second through hole 16 coaxial with the first through hole. This design allows the combination tumbler wheel 14 to achieve password input and verification through the alignment of the first through hole and the second through hole 16 when rotating, thereby enhancing the security and operational convenience of the combination lock.

During use, the lock cylinder 2 can be pressed to drive the lock cylinder 2 to move towards the lock bar body 6 until the ratchet teeth 3 of the lock cylinder 2 fully engage with the internal tooth slots of the lock bar fixed block 5. At this point, rotating the lock cylinder 2 can synchronously drive the lock bar fixed block 5 to rotate, thereby driving the lock bar body 6 to rotate. When rotation is not needed, the lock cylinder 2 is pulled outward until the ratchet teeth 3 disengage from the lock bar fixed block 5. At this time, the rotation of the lock cylinder 2 will no longer be transmitted to the lock bar fixed block 5 and the lock bar body 6, effectively preventing accidental operation and ensuring the reliability and safety of the clutch structure.

Meanwhile, in the embodiments of this application, an elastic element or damping device can also be added inside the lock cylinder 2, so that when the user presses or pulls the lock cylinder 2 to achieve clutch engagement, they can feel a noticeable tactile feedback. For example, when pressing to achieve engagement, there is a slight “click” sound and a change in resistance, allowing the user to clearly know the operational status and enhancing the user experience.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A clutch structure for a combination lock, comprising a combination lock module comprising a fixed ring and a lock cylinder connected to the fixed ring, wherein one end of the lock cylinder is provided with ratchet teeth, a side of the lock cylinder is provided with a rotational detent step, and one end of the lock cylinder is provided with a lock bar fixing block located within the rotational detent step, wherein the lock bar fixing block is connected to a lock bar body via a first pin, the rotational detent step is connected to the lock bar fixing block via a second pin, and a spring is arranged between the fixed ring and the lock bar fixing block.

2. The clutch structure for a combination lock according to claim 1, wherein a middle part of the lock cylinder is provided with a snap spring groove, and a snap spring body located on one side of the fixed ring is installed in the snap spring groove.

3. The clutch structure for a combination lock according to claim 2, wherein a round gasket is arranged between the snap spring body and the spring.

4. The clutch structure for a combination lock according to claim 1, wherein a middle part of the fixed ring is provided with an inwardly recessed annular groove, and a third pin located in the annular groove is inserted through the rotational detent step.

5. The clutch structure for a combination lock according to claim 1, wherein the combination lock module comprises a combination disc, and a middle part of the combination disc is provided with a plurality of combination tumbler wheels, wherein a first through hole penetrates a side of the combination tumbler wheel, and a side of the combination disc is provided with a second through hole arranged coaxially with the first through hole.

6. The clutch structure for a combination lock according to claim 1, wherein the side of the fixed ring is provided with a protrusion, and an inner side of the rotational detent step is provided with a sliding groove configured for the movement of the protrusion.

7. A clutch structure for a combination lock, comprising:
a lock module comprising a fixed ring and a lock cylinder connected to the fixed ring, with one end of the lock cylinder being provided with ratchet teeth; and
a rotational detent step, inside which a lock bar fixing block is provided, wherein the lock bar fixing block is connected to a lock bar body;
wherein the lock cylinder is capable of moving axially to selectively engage the ratchet teeth with the lock bar fixing block, and only when engaged, the rotation of the lock cylinder drives the lock bar body to rotate synchronously.

8. The clutch structure for a combination lock according to claim 7, wherein the lock bar fixing block is connected to the lock bar body via a first pin, allowing the lock bar fixing block and the lock bar body to rotate synchronously relative to the fixed ring.

9. The clutch structure for a combination lock according to claim 7, wherein the lock bar fixing block is arranged to be coaxial with the rotational detent step and is capable of rotating relative to the rotational detent step, a circumferential groove is provided on an outer periphery of the lock bar fixing block, and a second pin is provided on the rotational detent step, with the second pin extending into the circumferential groove to restrict an axial movement of the lock bar fixing block.

10. The clutch structure for a combination lock according to claim 7, wherein a spring is arranged between the fixed ring and the lock bar fixing block, and the spring is configured to force the lock cylinder to move axially relative to the lock bar fixing block for demeshing.

11. The clutch structure for a combination lock according to claim 10, wherein a middle part of the lock cylinder is provided with a snap ring groove, a snap ring body is installed in the snap ring groove, and the snap ring body abuts against the fixed ring to limit an axial displacement of the lock cylinder relative to the fixed ring.

12. The clutch structure for a combination lock according to claim 11, wherein a round gasket is arranged between the snap ring body and the spring.

13. The clutch structure for a combination lock according to claim 7, wherein the middle part of the fixed ring is provided with an inwardly recessed annular groove, and a third pin penetrates through the rotational detent step, the third pin being located within the annular groove to restrict the axial disengagement of the fixed ring relative to the rotational detent step.

14. The clutch structure for a combination lock according to claim 7, wherein the lock module further comprises a combination disc, and the combination disc is provided with a plurality of independently rotatable combination tumbler wheels, wherein each combination tumbler wheel is provided with a first through hole, and a side of the combination disc is provided with a second through hole coaxial with the first through hole.

15. The clutch structure for a combination lock according to claim 7, wherein the side of the fixed ring is provided with a protrusion, and an inner side of the rotational detent step is axially provided with a sliding groove configured for the movement of the protrusion.

16. A clutch structure for a combination lock, comprising a lock module and a lock bar group that are axially arranged, wherein the lock module comprises a fixed ring and a lock cylinder that is capable of rotating relative to each other, and the lock bar group comprises a rotational detent step, a lock bar fixing block and a lock bar body, wherein the lock bar body is fixedly connected to the lock bar fixing block, and the lock bar fixing block is arranged inside the rotational detent step and is capable of rotating relative to the rotational detent step;
wherein, the lock cylinder has an end that passes through the fixed ring and extends to the lock bar fixing block, the end being equipped with ratchet teeth, and the lock bar fixing block being provided with tooth slots that match the ratchet teeth; and wherein the lock cylinder is capable of moving axially relative to the lock bar fixing block and has a first working position and a second working position, wherein when the lock cylinder is in the first working position, the ratchet teeth engage with the lock bar fixing block to achieve synchronous rotation, and when in the second working position, the ratchet teeth disengage from the lock bar fixing block.

17. The clutch structure for a combination lock according to claim 16, wherein the rotational detent step has a cavity inside for the movement of the fixed ring, and the rotational detent step and the lock bar fixing block are respectively located at two axial ends of the cavity; and wherein a side of the fixed ring is provided with a protrusion, and an inner side of the rotational detent step is axially provided with a sliding groove for the protrusion to slide, wherein the sliding groove is configured to guide the fixed ring to move axially.

18. The clutch structure for a combination lock according to claim 17, wherein the lock bar fixing block is connected to the lock bar body via a first pin to achieve synchronous rotation, and the lock bar fixing block is arranged to be coaxial with the rotational detent step and is capable of rotating relative to the rotational detent step; and an outer periphery of the lock bar fixing block is provided with a circumferential groove, the rotational detent step is provided with a second pin extending into the circumferential groove to restrict the axial disengagement of the lock bar fixing block; and wherein a middle part of the fixed ring is provided with an inwardly recessed annular groove, and a third pin penetrating through the rotational detent step is located within the annular groove to prevent the axial disengagement of the fixed ring.

19. The clutch structure for a combination lock according to claim 17, wherein a spring is provided between the fixed ring and the lock bar fixing block, and the spring is configured to force the lock cylinder to move from the second working position to the first working position.

20. The clutch structure for a combination lock according to claim 17, wherein a middle part of the lock cylinder is provided with a snap ring groove, in which a snap ring is installed to abut against the fixed ring to limit the axial displacement of the lock cylinder, wherein a round gasket is arranged between the snap ring and the spring; and
wherein the lock module further comprises a combination disc, and the combination disc is provided with a plurality of independently rotatable combination tumbler wheels, wherein each combination tumbler wheel is provided with a first through hole, and aside of the combination disc is provided with a second through hole coaxial with the first through hole.
